(19) United States
(12) Patent Application Publication
(10) Pub. No.: US 2009/0030951 A1
(43) Pub. Date: Jan. 29, 2009

(54) PROGRAMMING APPARATUS AND AUTOMATIC DATA STRUCTURE IDENTIFICATION METHOD

(75) Inventor: Takuji Morita, Fukuoka (JP)

Correspondence Address: SUGHRUE-265550, 2100 PENNSYLVANIA AVE. NW, WASHINGTON, DC, 20037-3213, US

(73) Assignee: KABUSHIKI KAISHA YASKAWA DENKI, Kitakyushu-shi (JP)

(21) Appl. No.: 12/281,949

(22) PCT Filed: Feb. 21, 2007
(86) PCT No.: PCT/JP2007/053147

§ 371 Date: Sep. 5, 2008

(30) Foreign Application Priority Data
Mar. 7, 2006 (JP) 2006-061491

(51) Int. Cl. G06F 17/30

(52) U.S. Cl. 707/200; 707/E17.005

(57) ABSTRACT

When data access is made to an address type parameter having structured data, of a sequence command that constructs a sequence program, according to a conventional method, a user has to refer to a data structure described in a manual to calculate an offset address; therefore, there is a drawback that an incorrect data area is accessed due to miscalculation. An automatic data structure identification method solves the drawback. The automatic data structure identification method follows a procedure wherein data structure information is stored as a database, and when an access is made to a variable input to an address type parameter having structured data, the data structure information is read from the database, the data structure is displayed as a table, and an arbitrary variable is selected from the displayed table, so that the variable may be easily set to an arbitrary parameter of a sequence command.

### TECHNICAL FIELD

The present invention relates to a programmable controller programming apparatus, an automatic address parameter data structure identification method, and a programming apparatus thereof.

### BACKGROUND ART

When data access is made to an address type parameter having structured data, a conventional method follows a procedure wherein a user refers to a data structure described in a manual or the like to calculate an offset address of a data member, described in the manual, as an absolute address value of the variable input to the address type parameter (see Patent Document 1).

In such a method, due to miscalculation of the addresses of respective data member areas, there is a problem that incorrect data areas are accessed.

In FIG. 10, reference numeral 101 designates a sequence program, reference numeral 102 designates a sequence command in which structured data is provided as an address type parameter 103. Moreover, reference numeral 104 designates a variable input to the address type parameter 103, and reference numeral 105 designates a variable input to an arbitrary parameter of the sequence command, obtained by referring to a manual 106 or the like that describes a data structure to manually calculate a data address offset in order to make access to the variable 104, which is structured data.

In this manner, in a conventional programming apparatus of a programmable controller, in order to make access to structured data, a user has to follow a procedure wherein the user calculates an address with reference to a manual or the like that describes a data structure.

Patent Document 1: Japanese Patent Application Laid-Open (Kokai) Publication No. 2003-022182

### DISCLOSURE OF THE INVENTION

### Problems to be Solved by the Invention

When data access is made to an address type parameter having structured data, since the conventional method has to follows a procedure wherein a user refers to a data structure described in a manual or the like to calculate an offset address of a data member, described in the manual, as an absolute address value of the variable input to the address type parameter, there is a problem that incorrect data areas are accessed due to miscalculation of the addresses of respective data member areas.

The present invention has been made in consideration of such problems, and an object of the present invention is to provide a programming apparatus and an automatic address parameter data structure identification method, in which data structure information is stored as a database, so that when access is made to a variable input to an address type parameter having structured data, data structure information is read from the database, and the data structure is displayed as a table so that an arbitrary variable may be selected from the displayed table.

### Means for Solving the Problems

In order to solve the problems, according to a first aspect of the present invention, there is provided a programming apparatus, including: an input unit; a display unit; a memory having stored therein a sequence program that is constructed by a sequence command having structure data provided as an address type parameter and a data structure database that manages the structured data using a data member name, a data type, an offset address, and an offset bit address as data structure information; a CPU; a data structure database in which data structure information of the address type parameter of the sequence command is registered and managed; and a variable registration database that manages a variable input to the address type parameter, wherein the programming apparatus causes the CPU to display a sequence program of the display unit so that a variable input through the input unit in a parameter area of the sequence command of the sequence program is identified,

wherein the memory is further provided with a data structure information storage area in which data of the data structure database are expanded and a variable registration and storage area in which data of the variable registration database are expanded, and

wherein the CPU causes the data structure information of the address type parameter of the entire sequence commands supported by a controller to be managed by a management number in the data structure database, retrieves the variable input to the address type parameter of the sequence command on the sequence program from the data structure database in accordance with a name of the input sequence command and a name of the address type parameter, and registers the retrieved and read management number in the variable registration database as a data structure identification number of the input variable.

A programming apparatus according to a second aspect of the present invention is the programming apparatus according to the first aspect of the present invention, characterized in that the CPU reads in a variable input to an arbitrary parameter of the sequence command, retrieves the input variable from the variable registration database, search the data structure database based on the retrieved and read data structure identification number, and displays a data member name and an address as a table on the display unit based on the retrieved and read data structure information.

According to a third aspect of the present invention, there is provided an automatic address parameter data structure identification method for use in a programming apparatus having stored therein a sequence program constructed by a sequence command having structured data as an address type parameter, the programming apparatus being provided with a storage portion having stored therein a data structure database that manages the structured data using a data member name, a data type, an offset address, and an offset bit address as data structure information, the automatic data structure identification method follows a procedure wherein: the data structure information of the address type parameter of the entire sequence commands supported by a controller is managed by a management number in the data structure database; the variable input to the address type parameter of the sequence command on the sequence program is retrieved from the data structure database in accordance with a name of the input sequence command and a name of the address type parameter; and the retrieved and read management number is registered in the variable registration database as a data structure identification number of the input variable.

An automatic data structure identification method according to a fourth aspect of the present invention is the automatic data structure identification method according to the third aspect of the present invention, characterized in that the method follows a procedure wherein: a variable input to an arbitrary parameter of the sequence command is read in, and the input variable is retrieved from the variable registration database; the data structure database is searched based on the retrieved and read data structure identification number; and a data member name and an address are displayed as a table on the display unit based on the retrieved and read data structure information.

An automatic data structure identification method according to a fifth aspect of the present invention is the automatic data structure identification method according to the fourth aspect of the present invention, characterized in that an address of the data member displayed in the table is displayed such that an offset address registered in the data structure database, a relative address value of an offset bit address, is added to an address value of an input variable.

An automatic data structure identification method according to a sixth aspect of the present invention is the automatic data structure identification method according to the fifth aspect of the present invention, characterized in that the method follows a procedure wherein a corresponding data member is selected from the table, whereby a variable is set to an arbitrary parameter of the sequence command.

### ADVANTAGES OF THE INVENTION

As described above, in accordance with the first aspect of the present invention, it is possible to provide an easy-to-use programming apparatus, in which the data structure of the variable input to the address type parameter of the sequence command may be identified from the prepared data structure database in accordance with the name of the sequence command and the name of the address type parameter which are input thereto.

Moreover, in accordance with the second aspect of the present invention, since the data structure is displayed as a table when access is made to the variable input to the address type parameter, it is possible to provide an easy-to-use programming apparatus, in which the variable may be selected from the table without difficulties and may be set to an arbitrary parameter of the sequence command.

Furthermore, in accordance with the third aspect of the present invention, the data structure of the variable input to the address type parameter of the sequence command may be identified from the prepared data structure database in accordance with the name of the sequence command and the name of the address type parameter which are input thereto.

Furthermore, in accordance with the fourth aspect of the present invention, since the data structure may be displayed as a table by using the data structure database when access is made to the variable input to the address type parameter, the variable may be selected from the table without difficulties and may be set to an arbitrary parameter of the sequence command.

Furthermore, in accordance with the fifth aspect of the present invention, the table may perform display such that the offset address of the data structure is added to the address of the input variable. Furthermore, in accordance with the sixth aspect of the present invention, when a corresponding data member is selected from the displayed table, the variable may be set to an arbitrary parameter of the sequence command.

### BRIEF DESCRIPTION OF THE DRAWINGS

FIG. 1 is a block diagram for explaining a configuration of a programmable controller programming apparatus to which a method according to the present invention is applied.

FIG. 2 is a configuration diagram for explaining a data configuration of a data structure information storage area according to the present invention.

FIG. 3 is a configuration diagram for explaining a data configuration of a variable registration and storage area according to the present invention.

FIG. 4 is a configuration diagram for explaining a state in which a variable is set to a sequence command having structured data provided as an address type parameter according to the first aspect of the present invention.

FIG. 5 is a configuration diagram for explaining a state in which a data member and an address are displayed as a table according to the second and third aspects of the present invention.

FIG. 6 is a configuration diagram for explaining a state in which a corresponding data member is selected and a variable is set to an arbitrary parameter of a sequence command according to the fourth aspect of the present invention.

FIG. 7 is a flow chart for explaining a processing procedure according to the first aspect of the present invention.

FIG. 8 is a flow chart for explaining a processing procedure according to the second and third aspects of the present invention.

FIG. 9 is a flow chart for explaining a processing procedure according to the second and third aspects of the present invention.

FIG. 10 is a configuration diagram for explaining a convention method of making access to structured data.

### DESCRIPTION OF REFERENCE NUMBERS

11: INPUT DEVICE (KEYBOARD)
12: DISPLAY DEVICE
13: MAIN CONTROL UNIT (CPU)
14: STORAGE AREA (MEMORY)
15: DATA STRUCTURE INFORMATION STORAGE AREA
16: VARIABLE REGISTRATION AND STORAGE AREA
17: DATA STRUCTURE DATABASE
18: VARIABLE REGISTRATION DATABASE
21: MANAGEMENT NUMBER
22: SEQUENCE COMMAND NAME
23: ADDRESS TYPE PARAMETER NAME
24: MEMBER NUMBER
25: MEMBER NAME
26: DATA TYPE
27: OFFSET ADDRESS
28: OFFSET BYTE ADDRESS
31: REGISTRATION NUMBER
32: VARIABLE NAME
33: ADDRESS
34: DATA STRUCTURE MANAGEMENT NUMBER
41: SEQUENCE PROGRAM
42: SEQUENCE COMMAND
43: SEQUENCE COMMAND NAME
44: PARAMETER NAME
45: VARIABLE
51: SEQUENCE PROGRAM
52: SEQUENCE COMMAND
53: ARBITRARY PARAMETER
54: TABLE OF DATA MEMBER AND ADDRESS
61: SEQUENCE PROGRAM
62: SEQUENCE COMMAND
63: ARBITRARY PARAMETER
101: SEQUENCE PROGRAM
102: SEQUENCE COMMAND
103: ADDRESS TYPE PARAMETER
104: VARIABLE
105: MANUALLY CALCULATED AND INPUT VARIABLE
106: DATA STRUCTURE MANUAL

### BEST MODE FOR CARRYING OUT THE INVENTION

Hereinafter, specific embodiments of a method according to the present invention will be described with reference to the attached drawings.

### Embodiment 1

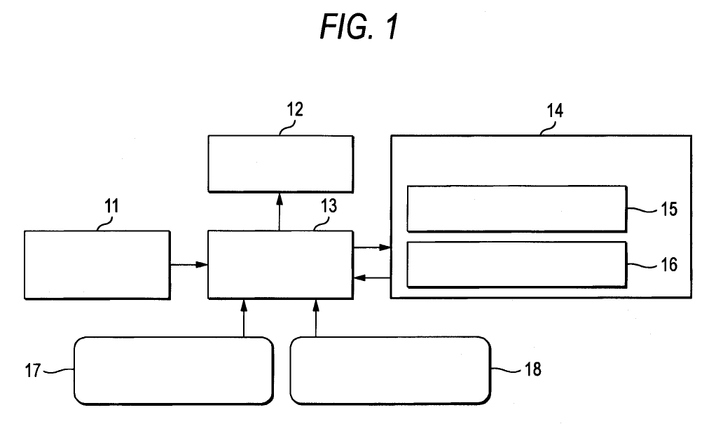

FIG. 1 is a block diagram illustrating the configuration of a programmable controller programming apparatus to which a method according to the present invention is applied. In the drawing figure, reference numeral 11 designates an input unit (keyboard), reference numeral 12 designates a display unit, and reference numeral 14 designates a storage area (a memory), which are all connected to a main control unit (CPU) 13.

The main control unit (CPU) 13 causes the display unit 12 to display a sequence program, so that a variable input through the input unit (keyboard) 11 in a parameter area of a sequence command of the sequence program is identified.

Moreover, reference numeral 17 designates a data structure database, in which data structure information of an address type parameter of the sequence command is registered and managed. Reference numeral 18 designates a variable registration database, in which a variable input to the address type parameter is managed.

Furthermore, reference numeral 15 designates a data structure information storage area provided on the storage area (memory), in which data of the data structure database 17 are expanded by the main control unit (CPU) 13. In addition, reference numeral 16 designates a variable registration and storage area in which data of the variable registration database 18 are expanded.

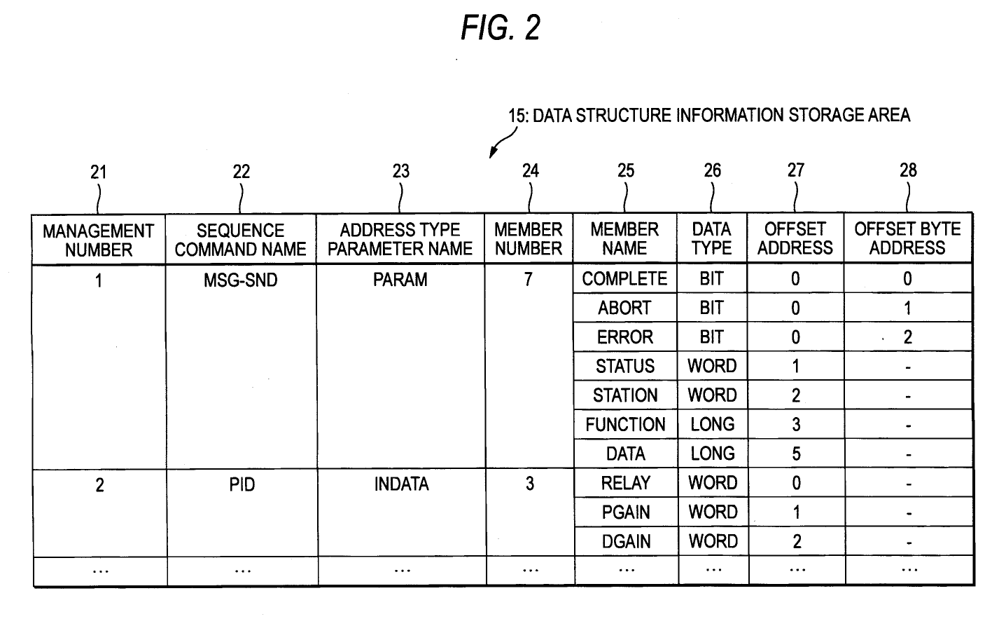

FIG. 2 is a data configuration diagram of the data structure information storage area 15. In the drawing figure, reference numeral 21 designates a management number for identifying the address type parameter of the sequence command, reference numeral 22 designates a sequence command name, reference numeral 23 designates an address type parameter name, reference numeral 24 designates the number of members that constitute the structured data, reference numeral 25 designates a member name, reference numeral 26 designates a data type, in which data types such as BIT, WORD, LONG and FLOAT are registered, and reference numeral 27 designates an offset address, in which relative address numbers of structured data are registered. Moreover, reference numeral 28 designates an offset bit address, which is effective when the data type 26 is BIT, and in which a relative bit address number of the offset address 27 is registered.

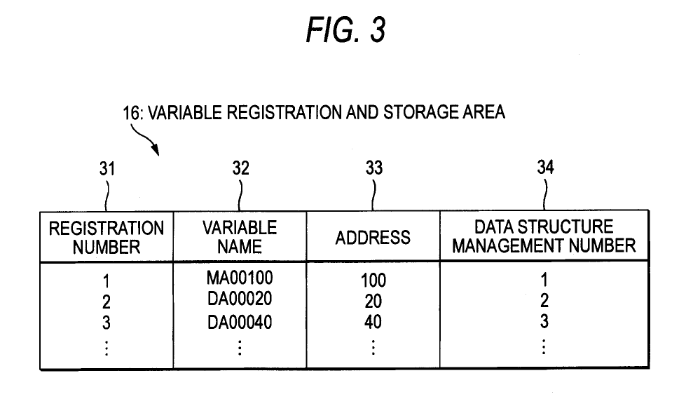

FIG. 3 is a configuration diagram of the variable registration and storage area 16. In the drawing figure, reference numeral 31 designates a registration number, in which a variable input to the address type parameter of the sequence command is managed. Moreover, reference numeral 32 designates a variable name, reference numeral 33 designates an address of a variable, and reference numeral 34 designates a data structure management number, which corresponds to the management number 21 configured in the data structure information storage area 15.

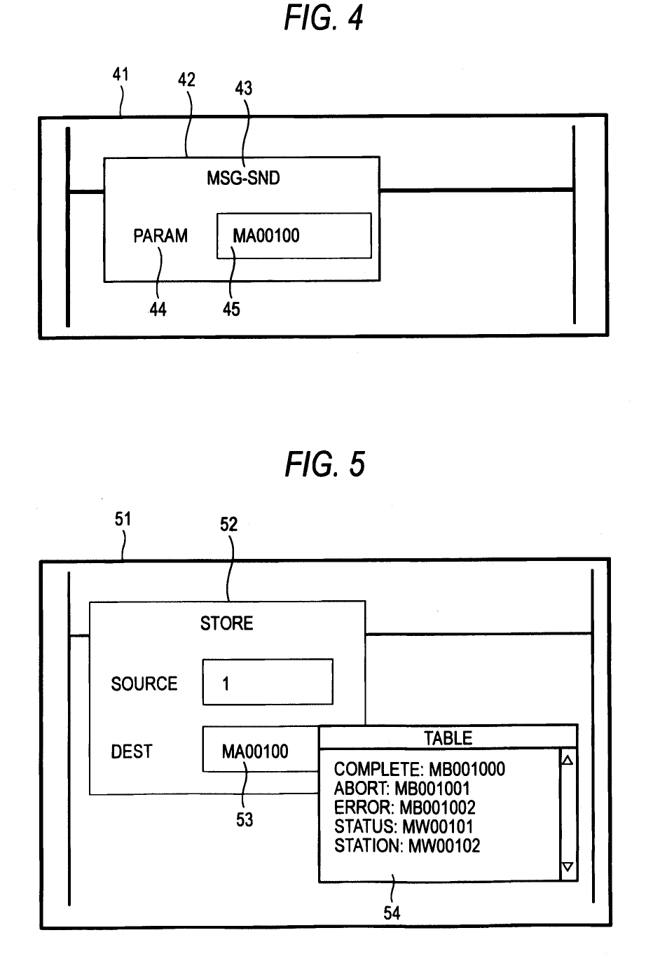

FIG. 4 is a diagram illustrating a state in which a variable is set to a sequence command having structured data provided as an address type parameter in accordance with the first aspect of the present invention.

In the drawing figure, reference numeral 41 designates a sequence program, reference numeral 42 designates a sequence program that constructs the sequence program 41, reference numeral 43 designates a sequence command name, and reference numeral 44 designates a parameter name, in which structured data are provided as an address type parameter. Moreover, reference numeral 45 designates a variable input to the parameter name 44.

In the drawing figure, the input variable 45 is read by the main control unit (CPU) 13 (FIG. 1) and retrieved from the data structure information storage area 15 (FIGS. 1 and 2) in accordance with the sequence command name 43 and the parameter name 44, and the management number 21 is retrieved and read and are registered together with the input variable 45 in the variable registration and storage area 16 (FIGS. 1 and 3).

FIG. 5 is a diagram illustrating a state in which a data member name and an address are displayed as a table in accordance with the second and third aspects of the present invention. In the drawing figure, reference numeral 51 designates a sequence program, reference numeral 52 designates a sequence command that constructs the sequence program 51, “SOURCE” or “DEST” designates an arbitrary parameter of the sequence command 52, reference numeral 53 designates an area in which a variable is written, and “1” or “MA00100” is a variable. In the drawing, a state is illustrated in which a variable which has been registered in the variable registration and storage area 16 (FIG. 3) is input. Moreover, reference numeral 54 designates a table showing a state in which a data member of the registered variable 53 and an address thereof are displayed.

The variable registered and input to the arbitrary parameter 53 is read by the main control unit (CPU) 13 (FIG. 1) and retrieved from the variable registration and storage area 16 (FIGS. 1 and 3), the member name 25 (FIG. 2), the data type 26, the offset address 27, and the offset bit address 18 are read in from the data structure information storage area 15 (FIGS. 1 and 2) based on the retrieved and read data structure management number 34 (FIG. 3), the offset address 27 is converted into the address 33 (FIG. 3), and a data member name and an address are displayed as a table.

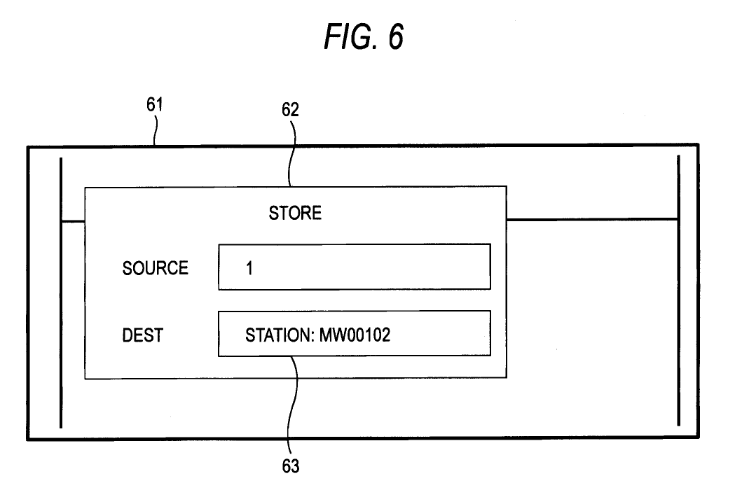

FIG. 6 is a diagram illustrating a state in which a corresponding data member is selected and a variable is set to an arbitrary parameter of a sequence command in accordance with the fourth aspect of the present invention. In the drawing figure, reference numeral 61 designates a sequence program, reference numeral 62 designates a sequence command that constructs the sequence program 61, and reference numeral 63 designates a state in which a variable is set to an arbitrary parameter of the sequence command 62. A data member and an address thereof selected from the table 54 of a data member and an address thereof are automatically set to the arbitrary parameter 63.

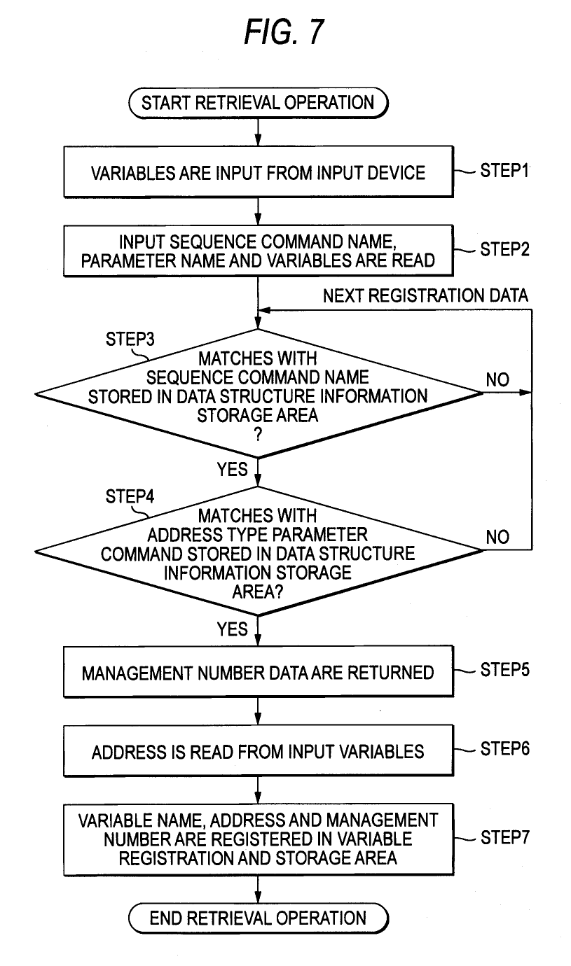

FIG. 7 is a flow chart illustrating a processing procedure in accordance with the first aspect of the present invention. A method according to the present invention will be described with reference to the flow chart.

First, in Step 1, a variable is input through the input unit (keyboard) 11 (FIG. 1) in the address type parameter of the sequence command as shown in FIG. 4. For example, a variable “MA00100” 45 is input to an address type parameter “PARAM” 44 of a sequence command “MSG-SND” 43. Subsequently, in Step 2, the main control unit (CPU) 13 (FIG. 1) reads in the variable “MA00100” input in Step 1, and the name of the sequence command 43 and the name of the address type parameter 44 are stored in the storage area.

Next, in Step 3, the sequence command name 22 stored in the data structure information storage area 15 (FIG. 2) and the sequence command name stored in Step 2 are compared with each other so that a matched sequence command is retrieved. Subsequently, in Step 4, the address type parameter name 23 stored in the data structure information storage area 15 (FIG. 2) and the address type parameter name stored in Step 2 are compared with each other so that a matched address type parameter name is retrieved.

Next, in Step 5, a management number of which the sequence command and the address type parameter are matched is acquired from the data structure information storage area 15 and stored in the storage area.

Next, in Step 6, an address number is acquired from the variable input in Step 1. The address number is configured such that the third and later characters from the starting character of the input variable “MA00100” 45 corresponds to an address, the starting character “M” represents an address type, and the second character “A” represents a data type.

Finally, in Step 7, the variable 45 input in Step 1, the address number acquired in Step 6, and the management number acquired in Step 5 are respectively stored in the variable name 32, the address 33, and the data structure management number 34 of the variable registration and storage area 16.

In this way, the variable input to the address type parameter of the sequence command may be registered in the variable registration and storage area 16 by reading in the management number from the data structure information storage area 15 based on the sequence command name and the address type parameter name.

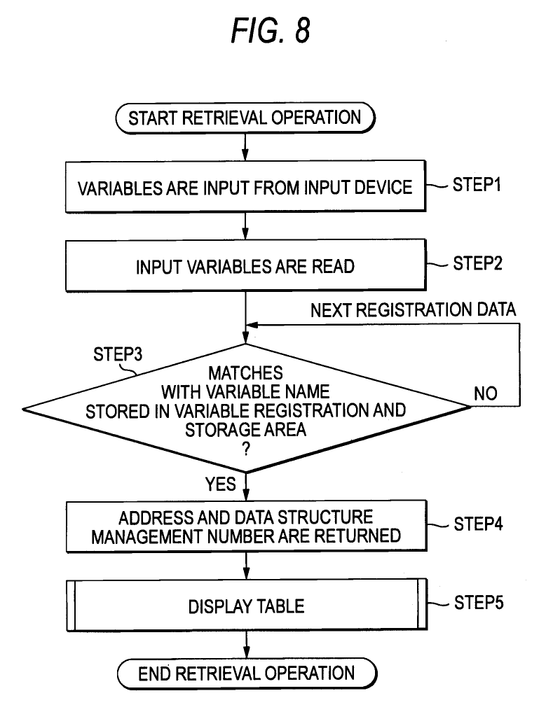

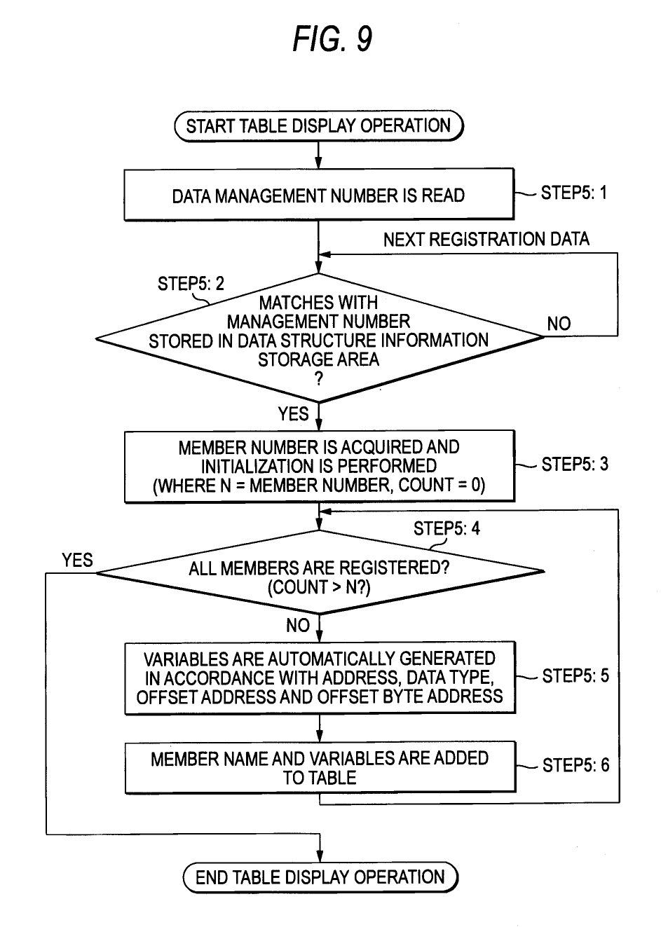

FIGS. 8 and 9 are flow charts illustrating a processing procedure in accordance with the second and third aspects of the present invention. A method according to the present invention will be described with reference to the flow charts.

First, in Step 1, a variable (“1” or “MA00100”) is input through the input unit (keyboard) 11 (FIG. 1) to the input area 53 of an arbitrary parameter (for example, “SOURCE” parameter, “DEST” parameter, and the like) of the sequence command 52 as shown in FIG. 5. For example, a variable “MA00100” 53 is input to a parameter “DEST” of a sequence command “STORE” 52. Subsequently, in Step 2, the main control unit (CPU) 13 reads in the variable “MA00100” input in Step 1 and the read variable is compared with the variable name stored in the variable registration and storage area 16 in Step 3, so that a matched variable name is retrieved. Subsequently, in Step 4, a matched address 33 and the data structure management number 34 are acquired and stored in the storage area.

Next, in Step 5.1 of FIG. 9, the data structure management number 34 acquired in Step 4 is read, and a management number that matches with the management number 21 stored in the data structure information storage area 15 is retrieved in Step 5.2. Subsequently, in Step 5.3, the member number 24 of the matched management number 21 is acquired. Moreover, in Step 5.4, subsequent operations are repeated by the number corresponding to the acquired member number, and a table display operation is performed, so that the process is completed when the entire members are registered.

In Step 5.5, the data type 26, the offset address 27, and the offset bit address 18 of a corresponding member are acquired, and a variable is generated by adding an offset value to the address 33 acquired in Step 4. The generated address is calculated by the following formula, and a bit address may be appended when the data type is BIT.

Formula: Address=Address 33(FIG. 3)+Offset Address 27(FIG. 2)

Finally, in Step 5.6 (FIG. 8), the member name 25 and the variable generated in Step 5.5 (FIG. 9) are displayed in the table 54 (FIG. 5).

In this way, when an input variable is registered in the variable registration and storage area 16, the data structure may be displayed as a table by the data structure management number 34 using the member name and the address thereof. Therefore, when an arbitrary address is selected from the table, a variable may be immediately set to the arbitrary parameter of the sequence command.

### INDUSTRIAL APPLICABILITY

According to the programming apparatus and the automatic data structure identification method according to the present invention, since the data structure information is provided as a database, when access is made to the address type parameter of the structured data, the data structure information is read in from the database, and the data structure is displayed as a table, so that an arbitrary variable may be selected from the table. Therefore, the apparatus and method according to the present invention may be applied not only to a programmable controller but also for other FA purposes.

### DESIGNATION OF DOCUMENT

### Drawings

### [FIG. 2]

15: DATA STRUCTURE INFORMATION STORAGE AREA
21: MANAGEMENT NUMBER
22: SEQUENCE COMMAND NAME
23: ADDRESS TYPE PARAMETER NAME
24: MEMBER NUMBER
25: MEMBER NAME
26: DATA TYPE
27: OFFSET ADDRESS
28: OFFSET BYTE ADDRESS

### [FIG. 3]

16: VARIABLE REGISTRATION AND STORAGE AREA
31: REGISTRATION NUMBER
32: VARIABLE NAME
33: ADDRESS
34: DATA STRUCTURE MANAGEMENT NUMBER

### [FIG. 5]

TABLE

### [FIG. 7]

START RETRIEVAL OPERATION
Step 1: VARIABLES ARE INPUT FROM INPUT DEVICE
Step 2: INPUT SEQUENCE COMMAND NAME, PARAMETER NAME, AND VARIABLES ARE READ
NEXT REGISTRATION DATA
Step 3: MATCHES WITH SEQUENCE COMMAND NAME STORED IN DATA STRUCTURE INFORMATION STORAGE AREA?
Step 4: MATCHES WITH ADDRESS TYPE PARAMETER COMMAND STORED IN DATA STRUCTURE INFORMATION STORAGE AREA?
Step 5: MANAGEMENT NUMBER DATA ARE RETURNED
Step 6: ADDRESS IS READ FROM INPUT VARIABLES
Step 7: VARIABLE NAME, ADDRESS, AND MANAGEMENT NUMBER ARE REGISTERED IN VARIABLE REGISTRATION AND STORAGE AREA
END RETRIEVAL OPERATION

### [FIG. 8]

START RETRIEVAL OPERATION
Step 1: VARIABLES ARE INPUT FROM INPUT DEVICE
Step 2: INPUT VARIABLES ARE READ
NEXT REGISTRATION DATA
Step 3: MATCHES WITH VARIABLE NAME STORED IN VARIABLE REGISTRATION AND STORAGE AREA?
Step 4: ADDRESS AND DATA STRUCTURE MANAGEMENT NUMBER ARE RETURNED
Step 5: DISPLAY TABLE
END RETRIEVAL OPERATION

### [FIG. 9]

START TABLE DISPLAY OPERATION
Step 5.1: DATA MANAGEMENT NUMBER IS READ
NEXT REGISTRATION DATA
Step 5.2: MATCHES WITH MANAGEMENT NUMBER STORED IN DATA STRUCTURE INFORMATION STORAGE AREA?
Step 5.3: MEMBER NUMBER IS ACQUIRED AND INITIALIZATION IS PERFORMED (WHERE N=MEMBER NUMBER, COUNT=0)
Step 5.4: ALL MEMBERS ARE REGISTERED? (COUNT>N?)
Step 5.5: VARIABLES ARE AUTOMATICALLY GENERATED IN ACCORDANCE WITH ADDRESS, DATA TYPE, OFFSET ADDRESS, AND OFFSET BYTE ADDRESS
Step 5.6: MEMBER NAME AND VARIABLES ARE ADDED TO TABLE
END TABLE DISPLAY OPERATION

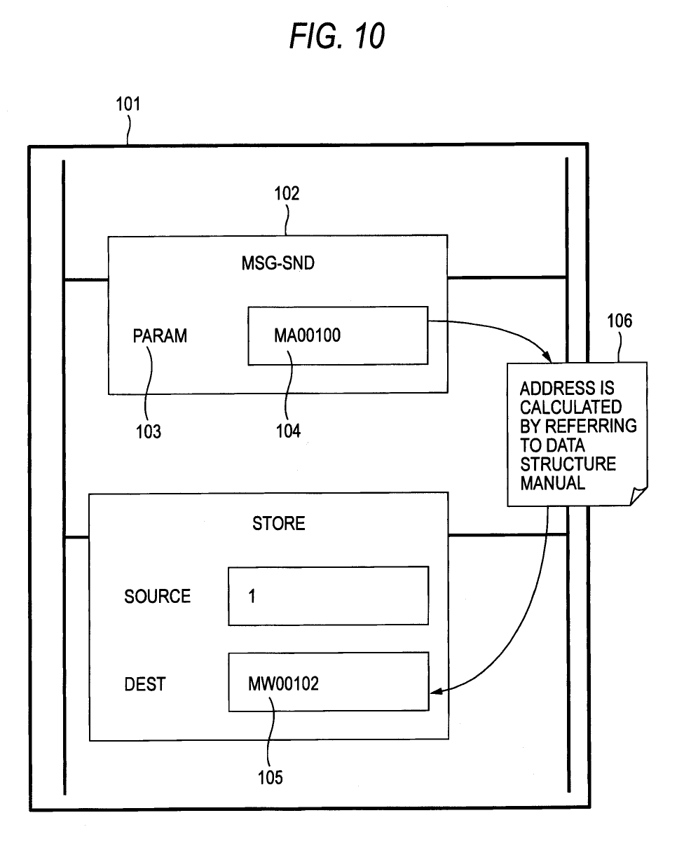

### [FIG. 10]

106: ADDRESS IS CALCULATED BY REFERRING TO DATA STRUCTURE MANUAL

1. A programming apparatus, comprising:
an input unit;
a display unit;
a memory which stores a sequence program that is constructed by a sequence command having a structured data provided as an address type parameter, and a data structure database that manages the structured data using a data member name, a data type, an offset address, and an offset bit address as a data structure information;
a CPU;
the data structure database in which the data structure information of the address type parameter of the sequence command is registered and managed; and
a variable registration database which manages a variable input to the address type parameter,
wherein a sequence program of the display unit is displayed the CPU so that a variable input through the input unit in a parameter area of the sequence command of the sequence program is identified,
wherein the memory is further provided with a data structure information storage area in which a data of the data structure database are expanded and a variable registration and storage area in which a data of the variable registration database are expanded, and
wherein the CPU manages a management number of the data structure information of the address type parameter of the entire sequence commands supported by a controller in the data structure database,
wherein the CPU retrieves the variable input to the address type parameter of the sequence command on the sequence program from the data structure database in accordance with a name of the input sequence command and a name of the address type parameter, and
wherein the CPU registers the retrieved and read management number in the variable registration database as a data structure identification number of the input variable.

2. The programming apparatus according to claim 1, wherein the CPU reads in a variable input to an arbitrary parameter of the sequence command, retrieves the input variable from the variable registration database, searches the data structure database based on the retrieved and read data structure identification number, and displays the data member name and the address as a table on the display unit based on the retrieved and read data structure information.

3. An automatic address parameter data structure identification method for use in a programming apparatus which stores a sequence program constructed by a sequence command having structured data as an address type parameter, the programming apparatus being provided with a storage portion which stores a data structure database that manages the structured data using a data member name, a data type, an offset address, and an offset bit address as a data structure information,
wherein the data structure information of the address type parameter of the entire sequence commands supported by a controller is managed by a management number in the data structure database,
wherein the variable input to the address type parameter of the sequence command on the sequence program is retrieved from the data structure database in accordance with a name of the input sequence command and a name of the address type parameter, and
wherein the retrieved and read management number is registered in the variable registration database as a data structure identification number of the input variable.

4. The automatic data structure identification method according to claim 3,
wherein a variable input to an arbitrary parameter of the sequence command is read in, and the input variable is retrieved from the variable registration database,
wherein the data structure database is searched based on the retrieved and read data structure identification number, and
wherein a data member name and an address are displayed as a table on the display unit based on the retrieved and read data structure information.

5. The automatic data structure identification method according to claim 4, wherein the address of the data member displayed in the table is displayed such that an offset address registered in the data structure database and a relative address value of an offset bit address are added to an address value of an input variable.

6. The automatic data structure identification method according to claim 5, wherein a corresponding data member is selected from the table, which a variable is set to an arbitrary parameter of the sequence command.
